(19) United States
(12) Patent Application Publication
(10) Pub. No.: US 2025/0250447 A1
(43) Pub. Date: Aug. 7, 2025

(54) WOOD COATING PRODUCTS CONTAINING VEGETAL-ORIGIN ANTI-OXIDANTS, AND METHODS TO MAKE THE SAME

(71) Applicant: VERINLEGNO S.P.A., Massa e Cozzile (IT)

(72) Inventors: Marco ROSSI, San Gimignano (IT); Mauro MARCHETTI, Sassari (IT)

(73) Assignee: VERINLEGNO S.P.A., Massa e Cozzile (IT)

(21) Appl. No.: 19/185,717

(22) Filed: Apr. 22, 2025

Related U.S. Application Data
(63) Continuation of application No. 17/439,263, filed on Sep. 14, 2021.

(51) Int. Cl. C09D 7/63; C08K 5/00; C08K 5/13; C09D 15/00

(52) U.S. Cl. CPC C09D 7/63; C08K 5/005; C08K 5/13; C09D 15/00

(57) ABSTRACT

A wood coating composition includes an acrylic or polyurethane or alkid resin, or a combination thereof; a water-based solvent comprising water and a polyalcohol, or an organic solvent selected among ketones, esters, aromatic hydrocarbons as toluene, alone or in a combination; wherein the resin has a weight ratio set between 10% and 80% or between the 20% the 70%, respectively with an or the other type of solvent. The compositions include a UV-protection additive comprising polyphenols, in particular a mixture of tannins extracted from such a wood as a Fagaceae, Mimosaceae or Rosaceae wood, at a weight ratio set between 0.5% and 4% with respect to the weight of the composition.

### CROSS-REFERENCE TO RELATED APPLICATIONS

This patent application is a continuation of U.S. application Ser. No. 17/439,263 filed Sep. 14, 2021, which is a nationalization of PCT Application PCT/IB2019/052134 filed Mar. 15, 2019, which applications are incorporated here by specific reference in their entirety.

### FIELD OF THE INVENTION

The present invention relates to wood coating products, i.e. wood varnish products as well as wood paint products, containing natural anti-oxidant additives, particularly suited for protecting outdoor wood items. In particular, environment-friendly water-based coating products are provided, but also organic solvent-based coating products are within the scope of the invention.

### DESCRIPTION OF THE PRIOR ART

As well known, most outdoor wood items are protected with varnish or paint products, comprising a cross-linking resin. Generally, these coatings also contain synthetic compounds such as UV-absorber additives and/or iron oxide-based pigments. Among the UV-absorbers, additives commercially known as Tinuvin 5151, Eversorb 33, Chiguard 5530, Chiguard 353, Irganox 1010 are mostly used. These additives include compounds that can interact with the natural UV and visible light, in order to prevent free radicals from forming to such an extent to trigger chain reactions that would involve the resin network. These chain reactions would cause such coating damages to the coating such as cracking, chalking, flaking and blistering, besides unfavourably affecting the colour and the appearance of the protective layer.

The above-mentioned UV-absorber additives are based on compounds including nitrogen atoms and substituted aromatic rings. In most cases, these are polluting and/or health hazardous compounds.

The need is therefore felt of additives for wood coating products that are at least as effective as currently used synthetic additives in preventing or at least considerably reducing free radical formation, while not being detrimental to the environment and hazardous for animal and human health.

To this purpose, coating products have been investigated and described that include additives based on natural compounds, typically on phenolic compounds. In particular, CN 103864985 (A) relates to the use of tea polyphenols in a light-and fire-resistant varnish. Polyphenols are embedded in liposomes in order to allow a delayed release thereof. Moreover, CN 104818829 (A) describes a floor coating in which a water-soluble varnish contains tea polyphenols and fruit-green pigments, while CN 104312323 describes the use of liposome-embedded tea polyphenols to obtain a good resistance against wide temperature excursions. Instead, WO 1996/040831 (A 1) relates to the use of flavonoid aldehydes as antimicrobials for paint and wood preservatives. As well known, the main component (more than 50-60%) of the polyphenols extracted from tea is epigallocatechin, having a molecular weight of about 458.

Tea polyphenols are not economically advantageous as anti-oxidant additives for wood coatings, due to their high cost. Moreover, large tea polyphenol amount would be required for a massive use as UV-protection additives in wood coatings, which would in turn require tea plantations too large to be economically and environmentally sustainable.

GB 2075538 A discloses storage stable metal primer compositions for converting rust into inert iron complexes and for depositing residual adherent protective latex primer coatings thereon. Besides water, these compositions comprise oil-in-water emulsions having components metal-chelating agents as the essential, selected among polyhydroxyphenyls and polyhydroxyphenyl carboxylic acids and their derivatives, in particular tannins and tannin derivatives. The compositions also comprise and acid-stable, low pH ionically stabilized latex in aqueous emulsion brought about by the incorporation of acid groups as a portion of the polymer molecules. The above-mentioned compounds can act as chelating agents only if the emulsion has a low pH, which is preferably set within 2.0 and 3.5.

WO 99/51694 A1 discloses antifoulant compositions including 10,10′-oxybisphenoxarsine and/or phenarsazine oxide with a quaternary ammonium salt. The antifoulant compositions can be used in fresh or seawater paints. Moreover, the antifoulant composition may be used to stain or impregnate wood, in order to preserve it. The composition can also contain adjuvants such as ultraviolet absorbers, and antioxidants.

### SUMMARY OF THE INVENTION

It is therefore a feature of the present invention to provide wood coating products suitable for protecting wood items, in particular outdoor items, from UV and visible light, said products containing UV-protection additives that are not detrimental to the environment and are not hazardous for animal and human health, in particular vegetable-origin additives.

It is a particular feature of the invention to provide such wood coating products that are much more resistant to UV radiations than the prior art products, and can therefore more effectively prevent such coating damages as cracking, chalking, flaking and blistering.

It is also a particular feature of the invention to provide such wood coating products that have a cost comparable with the cost of currently used coating products, in particular, wood coating products in which the UV additives do not decisively contribute to the final cost.

It is also particular feature of the invention to provide such wood coating products in which the vegetable origin additives can be obtained in an environmentally sustainable way.

It is also a particular feature of the invention to provide such wood coating products that can preserve the colour of the protected item for a longer time than the prior art products can do.

The above-mentioned objects are achieved by a water-based wood coating composition as defined by independent claim 1, and/or by an organic solvent-based wood coating composition as defined by independent claim 30. A method to obtain such coating products is also disclosed in claim 16 and throughout the description. Advantageous exemplary embodiments of the products and of the method are defined by the dependent claims.

In the description, the term “coating” can relate to a varnish or to a paint, i.e. it can be a substantially transparent product aiming at protecting the coated substrate, or it can be a product containing also a pigment, used to colour the coated item as well.

In the description, the expression “homogeneous mixture”, relates to grind fineness of the resin dispersed in the solvent. For instance, a grind fineness of the resin lower than 20 μm can be considered a suitably dispersed mixture for use as a varnish or a paint product, as measured according to UNI EN ISO 1524:2013 by means of a grindometer.

The wood coating compositions described hereinafter, to which the invention relates, comprise:
a solvent,
a resin selected from the group consisting of:
   an acrylic resin;
   a polyurethane resin;
   an alkid resin;
   a nitrocellulose resin;
   a combination thereof;
a UV-protection additive comprising polyphenols,
   wherein the UV-protection additive has a weight ratio set between 0.5% and 4% with respect to the composition;
   wherein the resin has a weight ratio set between 10% and 80% with respect to the composition.

The solvent of the composition can be either a water-based solvent or a fully organic solvent, as it will be more closely discussed in this description.

Polyphenols can work as UV-protection agents since they are able to dectivate the free radicals triggered by both UV and visible light radiation. For this reason, polyphenols maintain the colour tonality of the coating product even if this is almost permanently exposed to visible light radiation, as it happens in the case of outdoor coated items. The reasons are briefly explained hereinafter.

As known, the term “polyphenols” relates to a class of compounds comprising a plurality of phenol structural units, i.e. units in which normally multiple hydroxyl (—OH) groups are bond to respective aromatic phenyl rings. Polyphenols molecules are therefore highly electron-delocalized structures, providing a large availability of electron-donor groups for free-radical inactivation through a well-known mechanism, in which the radical extracts a hydrogen atom turning into a stabile compound and changing the polyphenol molecule first into a stable radical and then into a stable compound having an additional unsaturation for corresponding to the reacted donor groups.

The presence of water contributes to free-radical inactivation by the polyphenols, through the above mechanism, since water weakens the O—H bond of the hydroxyl electron-donor groups of the polyphenol molecules. In some conditions, some of the hydroxyl —OH groups can even be present in an ionic-O-form, as it will be described hereinafter. This effect on O—H bond makes it easier for a free radical to “extract” the hydrogen atom and the electron to compensate for the electron deficiency that characterized it, thus enhancing the activity of a polyphenol as a free-radical deactivator.

The effect of water on O—H bond stability, and therefore on free radical inactivation by the polyphenols is still present even after evaporation of the solvent accompanying the resin in the coating product as provided. In facts, water is still present in the environment where the coating spends its service life, as environmental moisture or as water always present even in the coated wood items, typically as absorbed water.

Moreover, the initial contribute of water to polyphenols free-radical inactivation activity via the O—H bond weakening is possible regardless the nature of the solvent of the coating product as provided. i.e., in the case of both a water-based solvent and a “fully”-organic solvent: organic solvents used to prepare the coating products are technical solvents that always contain a certain amount of water, and it is believed that this is enough for this effect to take place.

According to one aspect of the invention,
the solvent is a water-based solvent comprising water and a polyalcohol, i.e. a polyol, i.e. an organic compound comprising more than one hydroxyl group:
the resin is selected from the group consisting of:
   an acrylic resin;
   a polyurethane resin;
   an alkid resin;
   a combination thereof, in particular a mixture thereof;
the composition has a pH value higher than or at least equal to 7.

In some instances, when the resin itself is not able to provide such a pH value, the composition may contain an amount of an alkaline pH modifier in order to have the above mentioned pH value.

A method for making a wood coating product composition according to the invention, including a water-based solvent, comprises the steps of:
prearranging an amount of a water-based solvent comprising water and a polyalcohol;
prearranging an amount of a resin selected from the group consisting of:
   an acrylic resin;
   a polyurethane resin;
   an alkid resin;
   a combination, in particular a mixture thereof;
introducing the amount of the water-based solvent and the amount of the resin into a container;
stirring the amount of the water-based solvent and the amount of the resin within the container until a homogeneous mixture is obtained;
comparing a pH value of the mixture with a predetermined pH minimum value higher than or equal to 7;
   if the pH value of the mixture is lower than the predetermined minimum pH value, adding an amount of an alkaline pH modifier until the pH value of the mixture has reached a value at least as high as than the predetermined minimum pH value;
adding an amount of a UV-protection additive comprising complex polyphenols, obtaining said composition,
   wherein the UV-protection additive has a weight ratio set between 0.5% and 4% with respect to the composition,
   wherein the resin has a weight ratio set between 10% and 80% with respect to the composition.

More in detail, the use of the above-mentioned polyphenols as UV-protection additives in an alkaline or at least neutral composition turned out to be more effective by at least one magnitude order in inactivating the free radicals, in comparison with both synthetic and natural UV-protection prior art additives, as shown in the examples.

The additives according to the invention have also shown an at least comparable or even a higher capacity to protect the colours against UV radiations, in comparison with older and more recent mostly used UV-protection additives.

The solubility of polyphenols depends upon the pH value of the medium in which they are put. In this case, the pH value must be higher than or at least equal to 7, i.e. the composition must be neutral to alkaline, preferably it must be from slight to medium alkaline, i.e. higher than 7.5 or even than 8, as described hereinafter, so that the polyphenols can be solubilized. This way, the electronic delocalization is enhanced, which makes the polyphenols more effective in inactivating the free radicals triggered by the UV radiation. Actually, in these conditions, the bond dissociation energy of the O—H bonds becomes even weaker. Therefore, it will be easier for the free radicals to remove a hydrogen atom from the polyphenol. The latter itself becomes a stable radical and definitively a stable compound.

The bond dissociation energy of the O—H bonds is an important parameter in evaluating the antioxidant action, since the weaker the O—H bond, the easier will be the free radical-inactivation reaction.

In an acid environment, such as the environment described in prior art document GB 2075538 A, the hydroxyl group would not be present in the ionic form the polyphenols would hydrolyze forming smaller molecules, and could not be able to suitably work as UV-absorbers.

The pH-modifier of such a composition comprising a water-based solvent can be selected among ammonia, amines, alkaline or alkaline-earth hydroxides, an alkaline-earth carbonates. Preferably, the pH-modifier is ammonia or an amine.

Preferably, the pH minimum value is 7.5; more preferably, the pH minimum value is 8. In particular, said pH value is set between said pH minimum value and 11, more in particular between said pH minimum value and 10. In some instances, a too high pH value may lead to chemical bond breakup along the molecular chains of the resins, which would lower the coating resistance.

Preferably, in such a composition comprising a water-based solvent, the resin is selected between an anionic resin, a non-ionic resin, a combination thereof. Anionic and non-ionic resins do not interact with the ions dissolved in the water solvent of the composition and remain therefore solubilized in the neutral to basic environment, which in some instances may be provided by the pH-modifier. On the contrary, cationic resins could not work at such a pH value as 7 or higher, since they would precipitate as salt, and could not be used to make a coating product.

More in detail, the above-mentioned acrylic resins are preferably methacrylate-composed resins, formed from such monomers as acrylonitrile, acrylic acid, and providing hydroxyl groups. Preferably, these resins are enclosed within water-labile micelles adapted to react with anions and/or non-ionic compounds.

More in detail, the above-mentioned polyurethane resins are preferably mono-and bi-component resins providing hydroxyl groups. Preferably, these resins are enclosed within water-labile micelles adapted to react with anions and/or non-ionic compounds.

More in detail, the above-mentioned alkydic resins are preferably resins deriving from medium to short oil or modified polyesters. Preferably, these resins are enclosed within water-labile micelles adapted to react with anions and/or non-ionic compounds.

In some compositions as above/obtained as above, the resin weight ratio can be set between 20% and 50%. These compositions are well suited for wood impregnates, which can both protect and colour a wood substrate. Such compositions stand out for a very low dry matter, which allows them to penetrate the substrate surface layers. The products based on these compositions can be used both as primer layers and as finishing layers, for instance, to coat garden furniture, such as gazebos or the like.

In other compositions as above/obtained as above, the resin weight ratio can be set between 50% and 80%, in particular between 60% and 80%. These compositions are especially well suited for making coatings, in particular varnishes, both as primers, and as finishing or top-coating products, and can be used to obtain a stronger protection. Such compositions are also useful for making coatings, in particular varnishes, for such valuable articles as windows, doors, and for outdoor items in general.

In particular, in a composition as above/obtained as above, the polyalcohol of the water-based solvent has a weight ratio set between 1% and 6% with respect to the composition.

The polyalcohol of the water-based solvent is used for lowering the Minimum Film formation Temperature (MFFT) of the composition, so that the coating product can be used also at a relatively low temperature, for example at room temperature. For instance, the polyalcohol can be a glycol or a glycol-ether, and is preferably selected among butylene glycol, dibutylene glycol, propylene glycol n-butyl ether (DPnB), methoxypropanol, diethylene glycol, or can be a mixture of the these polyalcohols.

According to another aspect of the invention,:
the solvent is an organic solvent selected from the group consisting of:
   a ketone;
   an ester;
   an aromatic hydrocarbon selected among toluene, xylenes and a combination thereof;
   a combination thereof,
the resin has a weight ratio set between 20% and 70% with respect to the composition.
the UV-protection additive comprises a mixture of polyphenols deriving from aqueous extract of predetermined woods.

A method for making a wood coating product composition according to the invention, including an organic solvent, comprises the steps of:
prearranging an amount of an organic solvent selected from the group consisting of:
   a ketone;
   an ester;
   an aromatic hydrocarbon selected among toluene, xylenes and a combination thereof;
   a combination thereof,
prearranging an amount of a resin selected from the group consisting of:
   an acrylic resin;
   a polyurethane resin;
   an alkid resin;
   a nitrocellulose resin;
   a combination thereof;
introducing the amount of the water-based solvent and the amount of the resin into a container;
stirring the amount of the water-based solvent and the amount of the resin within the container until a homogeneous mixture is obtained;
adding an amount of a UV-protection additive comprising a mixture of polyphenols deriving from aqueous extract of predetermined woods,
   wherein the UV-protection additive has a weight ratio set between 0.5% and 4% with respect to the composition,
   wherein the resin has a weight ratio set between 20% and 70% with respect to the composition.

A s already stated, an enhancement of the activity of polyphenols is possible owing to water possibly present in the solvent used to prepare the composition and, after evaporation of the solvent, i.e. during the service life of the product, due to the water that is naturally present in the coated wood substrate.

In the case of the compositions comprising an organic solvent, a further enhancement to free radical deactivation activity, as shown by the examples provided hereinafter, is due to the use of a mixture of natural polyphenols as such, in particular tannins, i.e. of the polyphenols directly extracted from the wood of some plants. Surprisingly, these mixtures of polyphenols turned out to be more effective as UV absorbers to protect wood articles than most polyphenols currently used for the same purpose. In particular, these natural mixtures of polyphenols, used as UV absorbers according to the invention, are more effective than pure polyphenols. It is believed that mixtures of polyphenols having molecular weight spread over a relatively wide distribution of molecular weights is the reason for a far larger electronic delocalization, which, as already observed, is a condition for the polyphenols to inactivate the free radicals triggered by UV radiation, i.e. to work better as UV-absorbers.

The polyphenol-containing additive of the compositions containing an organic solvent is a vegetable additive extracted from a wood, in particular it can contain tannins. This is preferable also in the case of the compositions containing a water-based solvent, even if in that case tannins derivatives or synthetic tannins can be used as well. in particular the tannin can be selected from the group consisting of:
a Fagaceae tree tannin;
a Mimosaceae tree tannin;
a Rosaceae tree tannin;
a combination thereof.

Preferably, in all the compositions as above/obtained as above, the UV-protection additive comprises complex polyphenols having a molecular weight higher than 1000.

In particular, in a composition comprising an organic solvent, the resin weight ratio can be set between 10% and 70%. Among the compositions comprising an organic solvent, those having a resin weight ratio lower than 40% are suitable for both outdoor solvent for wood impregnates and solvent indoor varnishes. On the other hand, if the resin weight ratio is higher than 30%, the corresponding compositions can be used as primer layers and as finishing products, for both outdoor and indoor use.

All the above-mentioned resins are hydrophobic. They can therefore be dispersed into an organic solvent, which can be either an aliphatic solvent or an aromatic solvent. The organic solvent is selected among the ones listed above.

The acrylic resins can be water-based i.e. hybrid acrylic resins, self-crosslinking acrylic resins, hydroxylated acrylic resins, styrene-acrylic resins, and the like. As an alternative, solvent-based acrylic resins can be used, or both water-based and solvent-based polyurethane resins, or both water-based and solvent-based alkid resins, or solvent-based nitrocellulose resins.

The ketone used as the organic solvent, or as one of the organic solvents, can be methyl ethyl ketone, methyl isobutyl ketone, acetone, cyclohexanone, or a combination thereof. For example, the ester used as the organic solvent, or as one of the organic solvents, can be ethyl acetate, butyl acetate, methoxy propyl acetate, or a combination thereof. For example, the aromatic hydrocarbons used as organic solvents can be toluene and one of the xylenes, each alone or in combination with one another.

A composition comprising an organic solvent can also include an alcohol, with a weight ratio up to 5% with respect to the weight of the composition. This way, water-soluble materials containing polyphenols such as tannins can be made soluble also in the organic solvent. In particular, the alcohol can be butyl alcohol, isopropyl alcohol, ethyl alcohol and the like.

Conventional rheological additives can also be used in the compositions, i.e. additives suitable for modifying the viscosity, as well as levelling additives, i.e. additives suitable for lowering the surface tension. Moreover, antifoam additives and dispersing additives can be present, or any further additive commonly used in the field of the coatings for wood articles.

### Examples of Additives and Computing the Anti-Oxidant Activity

Three additives according to the invention have been selected, namely Fagaceae tannin, Mimosaceae tannin and Rosaceae tannin.

Moreover, as a reference for evaluating and comparing the anti-oxidant activity of the compositions, two synthetic compounds have been selected, which are commonly used as anti-oxidant additives, namely:
BHT (2,6-bis(1,1-dimethylethyl)-4-methylphenol;
Irganox 1010.

The above-mentioned compounds have been tested in order to evaluate their total anti-oxidant activity by a DPPH test. This consists in measuring the minimum amount or concentration of the compound that is required for attaining an EC₅₀ deactivation level, i.e. for deactivating 50% of DPPH (2,2 diphenyl-1-picrilidrazile), a stable radical. Table 1 shows the results of these tests.

TABLE 1
Anti-oxidant activity of UV-protection additives used in the invention,
and comparison with conventional UV-protection additives

| Anti-oxidant additive | mg/ml (*) |
|---|---|
| Fagaceae Tannin | 0.0010 |
| Mimosaceae Tannin | 0.0037 |
| Rosaceae Tannin | 0.0021 |
| 2,6-bis(1,1-dimethylethyl)-4-methylphenol (BHT) | 0.0260 |
| Irganox 1010 | 0.0093 |

(*) mg/ml of pure substance required for attaining EC₅₀ when deactivating the stable radical DPPH (1 ml of 5 mM ethanol solution of 2,2-diphenyl-1-picrilidrazile). The deactivation is proportional to the amount of anti-oxidant ethanol in the sample.

According to the results of Table 1, the amounts of the selected tannins required to deactivate DPPH up to a predetermined extent are far lower than the corresponding amounts of the typical conventional additives used as anti-oxidant protection additives in the wood coating products. It is therefore expected that the exemplary tannins, or the tannins in general, can work as UV-protection additives in a wood coating product far better than the additives most commonly used in wood coatings for this purpose.

### Examples of Wood Coating Products and Computing the Anti-Oxidant Activity

Five samples of varnishes containing 1% of an anti-oxidant additive have been prepared following the procedure described hereinafter.

Each sample was prepared by initially adding a water-based solvent comprising 280 g of water and 20 grams of a polyglicol mixture to 700 grams of a water-soluble acrylic resin under strong stirring. When the mixture appeared to be homogeneous, 1% by weight of a polyphenol anti-oxidant additive was added to each sample. More in detail, four samples of varnish containing anti-oxidant additives according to the invention i.e.:
Fagaceae tannin;
Mimosaceae tannin;
Rosaceae tannin
   were prepared, and two samples of varnish containing low molecular weight anti-oxidant additives of the prior art, i.e.:
biophenols from citrus waste;
tea biophenols.

These varnish samples have been tested by D PPH text as well. Table 2 shows the results of these tests.

TABLE 2
Anti-oxidant activity of compositions according
to the invention, and comparison with prior art
anti-oxidant additive-containing compositions

| Composition | | mg/ml (*) |
|---|---|---|
| Composition containing Fagaceae tannin | (1% by weight) | 0.24 |
| Composition containing Mimosaceae tannin | ″ | 2.96 |
| Composition containing Rosaceae tannin | ″ | 1.82 |
| Composition containing citrus waste | ″ | 0.91 |
| biophenols(**) | | |
| Composition containing tea biophenols(***) | ″ | 0.98 |

(*)mg/ml of pure substance required for attaining EC₅₀ when deactivating the stable radical DPPH (1 ml of 5 mM ethanol solution of 2,2-diphenyl-1-picrilidrazile). The deactivation is proportional to the amount of anti-oxidant charge in the sample.
(**)Concentrated extract of orange polyphenols
(***)Concentrated extract of green tea polyphenols

According to the results of Table 2, the compositions containing the Fagaceae tannin have the highest anti-oxidant activity. In particular, their anti-oxidant activity is higher than in the case of the compositions containing polyphenols known in the art as anti-oxidant additives, or in any case polyphenols having a molecular weight lower than 1000. The Fagaceae tannin confirms therefore the behaviour expected from the results of table 1.

The compositions containing the other high molecular weight tannins considered in the tests, i.e. Mimosaceae and Rosaceae tannins, show an anti-oxidant activity lower than in the case of the compositions containing Fagaceae tannin. However, most high-molecular weight tannins, among which all three above exemplary tannins, are much less expensive than lower molecular weight tannins presently used as anti-oxidant additives. M ore in detail, the cost of complex polyphenols according to the invention can be estimated as 1/80 of the cost of those low molecular weight biophenols. Therefore, the high molecular weight tannins according to the invention can advantageously replace the lower molecular weight polyphenols presently used as anti-oxidant additives for wood compositions.

### Examples of Wood Coating Compositions

The invention will be now shown with the description of some examples of wood coating formulations, exemplifying but not limitative.

Nine groups of compositions were prepared by adding amounts of a water based solvent (six groups of compositions of examples 1 to 6) or of a fully organic solvent (three groups of compositions of examples 7 to 9) to respective proportioned amounts of various resins belonging to the aforementioned categories, under stirring to disperse the resin in the solvent. The dispersions formed that way were checked for homogeneity, i.e. grind fineness, according to UNI EN ISO 1524:2013 using a grindometer for the measurements. Suitable homogeneity was considered to be obtained for a grind fineness between 0 and 20 μm as a result of these measurements.

### Example 1—Compositions Containing a Water-Based Solvent, an Anionic Acrylic Resin, and Mimosaceae tannin

10-80 grams of a polyglycol mixture have been added to 600-800 grams of a water-soluble anionic acrylic resin, under stirring. When the obtained mass appeared to be homogeneous, an amount between 0.5 and 2% of Mimosaceae tannin was added. During the preparation, strict care was taken in maintaining the pH of the samples between 7.5 and 10, which in some instances was obtained by using an alkaline pH modifier, in amounts up to 12 g.

### Example 2—Compositions Containing a Water-Based Solvent, an Anionic Acrylic Resin, and Fagaceae tannin

40-100 grams of a polyglycol mixture have been added to 400-700 grams of a water-soluble anionic acrylic resin, under stirring. When the obtained mass appeared to be homogeneous, an amount between 0.5% and 2% of Fagaceae tannin was added. During the preparation, strict care was taken in maintaining the pH of the samples between 7.5 and 10, which in some instances was obtained by using an alkaline pH modifier, in amounts up to 14 g.

### Example 3—Compositions Containing a Water-Based Solvent, a Non-Ionic Acrylic Resin, and Rosaceae tannin

20-80 grams of a polyglycol mixture have been added to 500-800 grams of a water-soluble non-ionic acrylic resin, under stirring. When the obtained mass appeared to be homogeneous, an amount between 0.5 and 2% of Rosaceae tannin was added. During the preparation, strict care was taken in maintaining the pH of the samples between 7.5 and 10, which in some instances was obtained by using an alkaline pH modifier, in amounts up to 15 g.

### Example 4—Compositions Containing a Water-Based Solvent, a Non-Ionic Acrylic Resin, and Fagaceae tannin

20-80 grams of a polyglycol mixture have been added to 450-750 grams of a water-soluble non-ionic acrylic resin, under stirring. When the obtained mass appeared to be homogeneous, an amount between 0.5% and 2% of Fagaceae tannin was added. During the preparation, strict care was taken in maintaining the pH of the samples between 7.5 and 10, which in some instances was obtained by using an alkaline pH modifier, in amounts up to 14 g.

### Example 5—Compositions Containing a Water-Based Solvent, an Alkid Resin, and Fagaceae tannin

40-100 grams of a polyglycol mixture have been added to 400-700 grams of a water-soluble alkid resin, under stirring. When the obtained mass appeared to be homogeneous, an amount between 0.5% and 2% of Fagaceae tannin was added. During the preparation, strict care was taken in maintaining the pH of the samples between 7.5 and 10, which in some instances was obtained by using an alkaline pH modifier, in amounts up to 10 g.

### Example 6—Compositions Containing a Water-Based Solvent, a Polyurethane Resin, and Fagaceae tannin

30-80 grams of a polyglycol mixture have been added to 500-700 grams of a water-soluble polyurethane resin, under stirring. When the obtained mass appeared to be homogeneous, an amount between 0.5% and 2% of Fagaceae tannin was added. During the preparation, strict care was taken in maintaining the pH of the samples between 7.5 and 10, which in some instances was obtained by using an alkaline pH modifier, in amounts up to 11 g.

### Example 7—Compositions Containing a Fully Organic Solvent, an Alkid Resin, and Mimosaceae tannin

40-80 grams of a hydrocarbon mixture have been added to 400-600 grams of an alkid resin, under stirring. When the obtained mass appeared to be homogeneous, an amount between 1% and 2% of Mimosaceae tannin was added. The Mimosaceae tannin had previously been dissolved in an organic solvent, in order to allow a full dissolution in the sample being formed.

### Example 8—Compositions Containing a Fully Organic Solvent, a Polyurethane Resin, and Rosaceae tannin

60-120 grams of a mixture of carbonyl compounds have been added to 500-700 grams of a polyurethane resin, under stirring. When the obtained mass appeared to be homogeneous, an amount between 1.5% and 3% of Rosaceae tannin was added. The Rosaceae tannin had previously been dissolved in an organic solvent, in order to allow a full dissolution in the sample being formed.

### Example 9—Compositions Containing a Fully Organic Solvent, an Acrylic Resin, and Fagaceae tannin

100-150 grams of a mixture of carboxylic compounds have been added to 500-700 grams of an acrylic resin, under stirring. When the obtained mass appeared to be homogeneous, an amount between 1% and 3% of a Fagaceae tannin was added. The Fagaceae tannin had previously been dissolved in an organic solvent, in order to allow a full dissolution in the sample being formed.

### Characterization a of an Exemplary Wood Varnish Product

### Protecting the Colour From the Effects of UV Radiations

Tests have been made according to EN ISO 11507:2007 to evaluate the colour stability of four different finishing varnishes on durmast wood and pine wood samples. The finishing varnishes contained four different additives, among which two additives according to the invention, i.e.:
a Fagaceae tannin;
a Mimosaceae tannin,
   and two known UV-protection additives, i.e.:
Tinuvin 5151, a traditional UV-absorber;
Nanobyk 3840, a more recent UV-absorber.

The coated wood samples were maintained at constant temperature and humidity during a stabilization time according to the above EN standard. Afterwards, a test was carried out consisting in alternately exposing the samples to UV-B radiation and rising the relative humidity, during an overall test time of two weeks. The colour was spectrophotometrically determined before and after the test. Table 3 shows the result of these measurements, in the case of the varnishes containing a tannin, as average values obtained by a same group of compositions.

TABLE 3

| | |
|---|---|
| Durmast wood samples | |
| 1) Compositions of Example 1 | Δeab = 1.54 |
| 2) Compositions of Example 2 | Δeab = 1.05 |
| 3) Composition containing Tinuvin 5151 | Δeab = 2.84 |
| 4) Composition containing Nanobyk 3840 | Δeab = 1.12 |
| Pinewood samples | |
| 5) Compositions of Example 1 | Δeab = 2.07 |
| 6) Compositions of Example 2 | Δeab = 1.31 |
| 7) Composition containing Tinuvin 5151 | Δeab = 3.32 |
| 8) Composition containing Nanobyk 3840 | Δeab = 1.64, |

where Δeab is the difference of the light emission of a sample irradiated between before and after the treatment briefly described above. More in detail, this difference is defined as the square root of the difference of the squares of the absorbance measured according to three axes, i.e. a bright/dark axis, a yellow/blue axis and a green/red axis. The lower Δeab, the higher is the colour preservation power of the varnish.

According to the results of Table 3, the Fagaceae tannin is in any case more effective than the reference conventional additives, regardless of the coated wood substrate. An anti-oxidant effect globally comparable with that of the conventional additives is determined also for Mimosaceae tannin, depending in this case on the coated wood substrate.

Moreover, even in this case, the Fagaceae tannin turned out to be the most effective as an additive for obtaining a coating having an anti-oxidant activity.

Even if in the examples more extensive reference is made to varnishes, the results obtained from the text can be extended to coating products in general, e.g. to paint products based on the compositions according to the invention, also containing pigments.

The foregoing description of exemplary embodiments and specific examples of the invention will so fully reveal the invention according to the conceptual point of view, so that others, by applying current knowledge, will be able to modify and/or adapt for various applications such embodiment without further research and without parting from the invention, and, accordingly, it is to be understood that such adaptations and modifications will have to be considered as equivalent to the specific embodiment and examples. The means and the materials to put into practice the different functions described herein could have a different nature without, for this reason, departing from the field of the invention. It is to be understood that the phraseology or terminology employed herein is for the purpose of description and not of limitation.

1. A method of wood coating for protecting an outdoor wood item from UV and visible light, comprising:
preparing a composition comprising:
a water-based solvent comprising water and a polyalcohol,
a resin selected from the group consisting of:
an acrylic resin;
a polyurethane resin;
an alkyd resin; and
a combination thereof; and
a UV-protection additive comprising polyphenols, wherein said UV-protection additive has a weight ratio set between 0.5% and 4% with respect to said composition,
wherein said resin has a weight ratio set between 10% and 80% with respect to said composition;
wherein said composition has a pH value selected between 7 and a value higher than 7, and
applying said composition on said wood item. 2 The method according to claim 1, wherein said UV-protection additive containing complex polyphenols is a tannin.

3. The method according to claim 2, wherein said tannin is selected from the group consisting of:
a Fagaceae tree tannin;
a Mimosaceae tree tannin;
a Rosaceae tree tannin; and
a combination thereof.

4. The method according to claim 1, wherein said additive containing complex polyphenols is a tannin derivative, or a synthetic tannin.

5. The method according to claim 1, wherein said UV-protection additive comprise complex polyphenols having a molecular weight higher than 1000.

6. The method according to claim 1, also containing an alkaline pH-modifier.

7. The method according to claim 1, wherein said pH-modifier is selected from the group consisting of ammonia, an amine, an alkaline or alkaline-earth hydroxide, an alkaline-earth carbonate.

8. The method according to claim 1, wherein said pH minimum value is 7.5.

9. The method according to claim 8, wherein said pH minimum value is 8.

10. The method according to claim 1, wherein said pH value is set between said pH minimum value and 11.

11. The method according to claim 10, wherein said pH value is set between said pH minimum value and 10.

12. The method according to claim 1, wherein said resin is selected between an anionic resin, a non-ionic resin, a combination thereof.

13. The method according to claim 1, wherein said weight ratio of said resin is set between 20% and 50%.

14. The method according to claim 1, wherein said weight ratio of said resin is set between 50% and 80%.

15. The method according to claim 1, wherein said polyalcohol has a weight ratio set between 1% and 6% with respect to said composition.

16. The method according to claim 15, wherein said polyalcohol is selected from the group consisting of: butylene glycol, dibutylene glycol, propylene glycol n-butyl ether, methoxypropanol, diethylene glycol.
